(19) United States
(12) Patent Application Publication
(10) Pub. No.: US 2012/0218415 A1
(43) Pub. Date: Aug. 30, 2012

(54) IMAGING INTRUSION DETECTION SYSTEM AND METHOD USING DOT LIGHTING

(75) Inventors: Kyong-Joon Chun, Seoul (KR); Moo-Kyung Park, Seoul (KR); Ki-Il Koo, Seoul (KR)

(73) Assignee: S1 CORPORATION, Seoul (KR)

(21) Appl. No.: 13/393,943

(22) PCT Filed: Aug. 19, 2010
(86) PCT No.: PCT/KR2010/005489

§ 371 Date: May 9, 2012

(30) Foreign Application Priority Data
Sep. 4, 2009 (KR) 10-2009-0083328

(51) Int. Cl. H04N 7/18

(52) U.S. Cl. 348/152; 348/E07.085

(57) ABSTRACT

An imaging intrusion detection method combines condensing lenses with a plurality of light sources to form and illuminate a plurality of collimated light beams to a security area as dot lighting. A dot image of the security area to which the dot lighting is illuminated by an intrusion monitoring camera is obtained and stored in a memory as reference dot information. When an input image is obtained by periodically photographing the security area, dot information is extracted from the input image to compare the dot information with the reference dot information, and it is determined whether there is an intrusion in the security area according to a change of a dot based on a result of comparison.

### FIELD OF THE INVENTION

The present invention relates to a method for detecting an intrusion, and particularly to an imaging intrusion detection system and method for detecting an intrusion by using dot lighting such as a light emitting diode (LED).

### DESCRIPTION OF THE RELATED ART

Generally, an imaging intrusion detection system illuminates security areas with a light emitting diode (LED) of visible light or infrared light when it is dark, photographs the areas to obtain an image, and detects an intruder by using an image recognition technique.

The intensity of illumination is reduced in proportion to a square of a distance as the distance from a light source increases. The imaging intrusion detection system has a difficulty in detecting an image and an image error by outside lighting increases because the intensity of illumination is reduced as the distance from the light source increases when the light source is close to a camera.

The imaging intrusion detection system has a problem of increasing power consumption when an illumination lamp is always turned on to detect an intrusion in the dark.

Also, a scheme for illuminating with an infrared LED around a camera is generally used in the imaging intrusion system. In this case, the detectable distance is restricted to be lower than 10 m because the output of the infrared LED is weak.

As described above, there are problems that a detectable distance becomes short and an image error increases in the dark when the image intrusion system uses a general light such as the infrared LED.

### DETAILED DESCRIPTION OF THE INVENTION

### Object of the Invention

The present invention has been made in an effort to provide an imaging intrusion detection system and method having advantages of forming dot lighting by using an infrared light emitting diode and detecting intrusion according to the change of dot light.

### Technical Object to be Accomplished of the Invention

An exemplary embodiment of the present invention provides an imaging intrusion detection method for an imaging intrusion detection system by using an image recognition technique. The imaging intrusion detection method includes generating a plurality of collimated light beams by respectively combining condensing lenses with a plurality of light sources and illuminating a security area by the plurality of collimated light beams to form dot lighting; obtaining a dot image of the security area to which the dot lighting is illuminated by an intrusion monitoring camera and storing the obtained dot image in a memory as reference dot information; and photographing the security area to which the dot lighting is illuminated at predetermined intervals to obtain an input image, extracting dot information from the input image to compare the dot information with the reference dot information, and determining whether there is intrusion in the security area according to a change of a dot based on a result of comparison.

Another exemplary embodiment of the present invention an imaging intrusion detection system using an image recognition technique. The imaging intrusion detection system includes a dot lighting unit in which a plurality of light sources are respectively combined with condensing lenses to form a plurality of collimated light beams, and that illuminates a security area with the plurality of collimated light beams to form dot lighting; and an intrusion determining unit that sets a dot image of the security area in which the dot lighting is illuminated as reference dot information, and when an input image for the security area is obtained, extracts dot information from the input image, compares the dot information with the reference dot information, and analyzes a change of a dot to determine whether there is an intrusion.

### Effects

According to exemplary embodiments of the present invention, a plurality of collimated light beams that are formed by combining condensing lenses to light sources are illuminated far and wide. Therefore, a detection distance is increased, image nondetection is reduced, and image errors cause by outside light are reduced.

Also, it is possible to reduce power consumption of lighting by illuminating a security area by dot lighting, compared with illuminating the entire security area with a plurality of lighting devices.

In addition, by arranging a plurality of dot light beams in the form of a zigzag, it is possible to detect an intrusion when an intruder trespasses in security area from any direction.

Further, it is possible to determine whether there is an intruder, the movement of the intruder, the movement direction of the intruder, and the movement speed of the intruder by analyzing the plurality of dot lights, so false alarms are prevented.

In addition, it is possible to know the size of a trespassing object, thereby false alarms cause by mice, cats, and other animals is prevented.

### BRIEF DESCRIPTION OF THE DRAWINGS

FIG. 1 shows a block diagram of an imaging intrusion detection system by using dot lighting according to an exemplary embodiment of the present invention.

FIG. 2 shows an example in which an infrared light emitting diode (LED) and a condensing lens are installed according to an exemplary embodiment of the present invention.

FIG. 3 shows an example in which a plurality of light sources are arranged in the form of a zigzag with the optical axis of a camera as its center according to an exemplary embodiment of the present invention.

FIG. 4 shows an example in which infrared LEDs are arranged in the form of a circle with a camera as its center according to an exemplary embodiment of the present invention.

FIG. 5 shows an example in which an infrared LED is further arranged around a camera according to an exemplary embodiment of the present invention.

FIG. 6 shows dot images obtained by illuminating a security area by a dot lighting unit according to an exemplary embodiment of the present invention.

FIG. 7 shows an example of driving a light source with direct current according to an exemplary embodiment of the present invention.

FIG. 8 shows an example of driving a light source with pulse signals according to an exemplary embodiment of the present invention.

FIG. 9 shows a principle of synchronizing an intrusion monitoring camera and a light source according to an exemplary embodiment of the present invention.

FIG. 10 shows dot images obtained when there is no intruder according to an exemplary embodiment of the present invention.

FIG. 11 shows dot images obtained when there is an intruder according to an exemplary embodiment of the present invention.

FIG. 12 shows images obtained when there is an intruder according to an exemplary embodiment of the present invention.

FIG. 13 shows a flowchart of an imaging intrusion detection method using dot lighting according to an exemplary embodiment of the present invention.

FIG. 14 shows an intrusion moving path of an intruder according to an exemplary embodiment of the present invention.

FIG. 15 and FIG. 16 show a method for reducing the effect of white noise according to an exemplary embodiment of the present invention.

FIG. 17 shows a principle of measuring angle of view and size of an object by positions in a security area according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Through the specification, in addition, unless explicitly described to the contrary, the word “comprise” and variations such as “comprises” or “comprising” will be understood to imply the inclusion of stated elements but not the exclusion of any other elements.

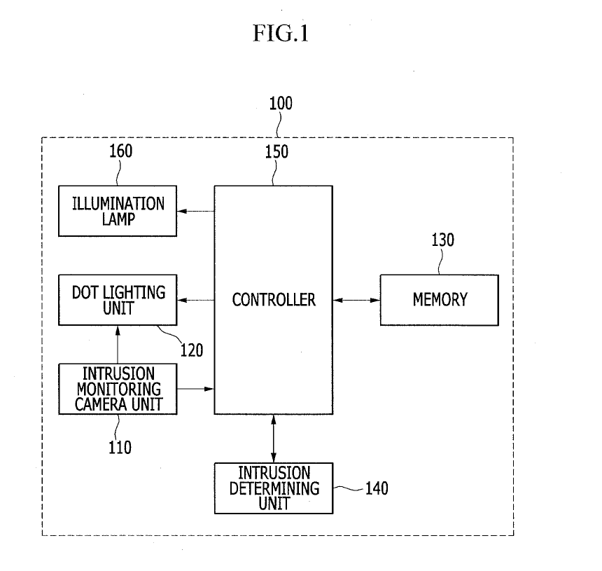

FIG. 1 shows a block diagram of an imaging intrusion detection system by using dot lighting according to an exemplary embodiment of the present invention.

The imaging intrusion detection system 100 includes an intrusion monitoring camera unit 110, a dot lighting unit 120, a memory 130, an intrusion determining unit 140, and a controller 150. In addition, an illumination lamp 160 that is able to be turned on or off is further included.

The intrusion monitoring camera unit 110 photographs an image of a security area in a security mode.

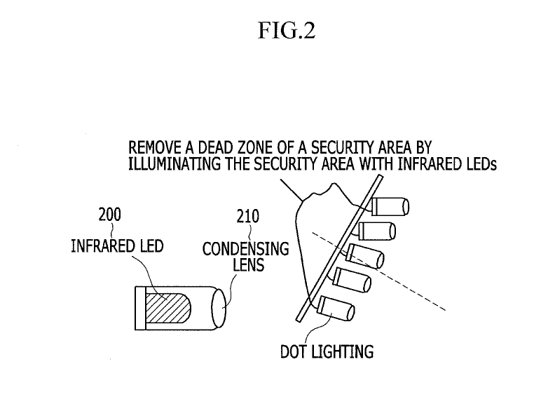

The dot lighting unit 120 forms collimated light with a plurality of infrared LEDs 200 and condensing lenses 210. Here, each condensing lens, as shown in FIG. 2, is able to be adhered to each LED or one condensing lens is able to be installed in front of all the LEDs to form a plurality of collimated light beams.

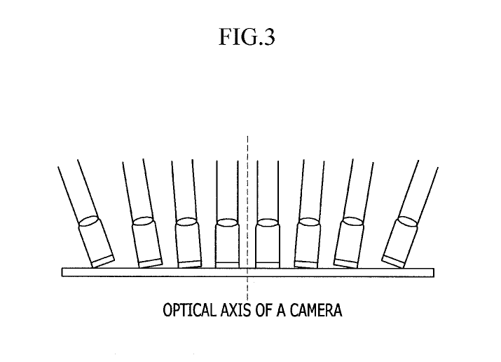

The illuminating directions of the infrared LEDs 200, as shown in FIG. 3, are dispersed from the optical axis of the intrusion monitoring camera unit 110 so that the plurality of collimated light beams illuminate the security area evenly.

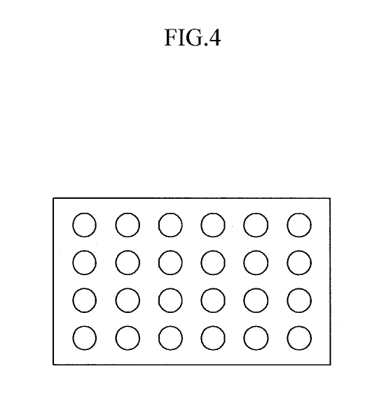

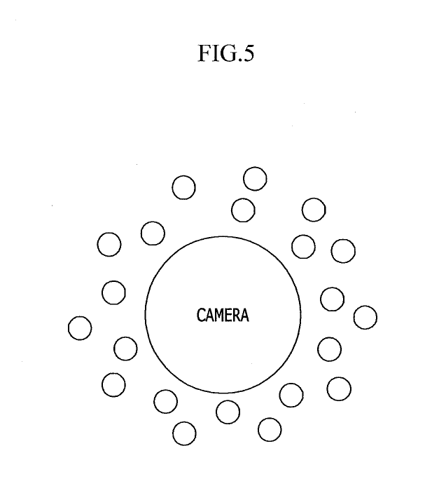

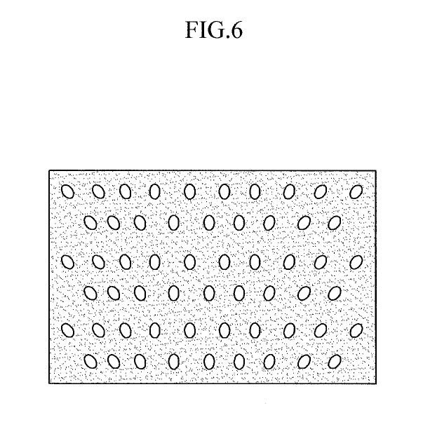

The infrared LEDs 200 may be disposed around the intrusion monitoring camera unit 110 or disposed in the form of a circle with the optical axis of the intrusion monitoring unit 110 as its center, as shown in FIG. 4 and FIG. 5, respectively. Also, as shown in FIG. 6, the infrared LEDs 200 may be disposed in the form of a zigzag with the optical axis of the intrusion monitoring camera unit 110 as its center.

The dot lighting unit 120 generates a plurality of collimated light beams to form dot lighting to the security area. The thinner the thickness of the beam is, the farther away the intensity of illumination of the beam is maintained, which is effective for reduction of nondetection of intrusion and false alarms.

For example, the area of the entire security area is 5 m×5 m=25 m² (250,000 cm²) and the area of one dot light beam is 1 cm². When there are 25 dot light beams, the brightness of the entire dot lighting formed by the dot light beams is much brighter by 10,000 times than that of the equal lighting for illuminating the security area by one light beam.

Therefore, the dot lighting unit 120 can illuminate farther and wider with the same power and false alarms caused by outside light decrease, and thereby it is possible to reduce the nondetection and false alarms.

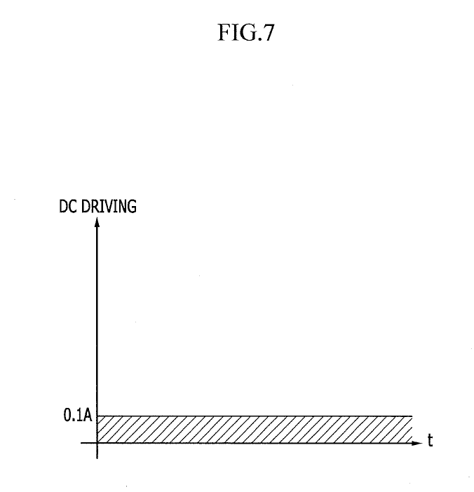

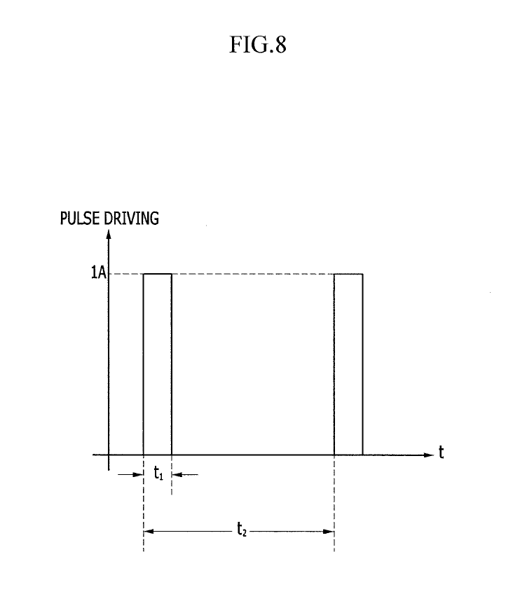

The dot lighting unit 120 can drive the infrared LEDs 200 with direct current as shown in FIG. 7, or drive the infrared LEDs 200 with pulse signals as shown in FIG. 8.

When the dot lighting unit 120 drives the infrared LEDs 200 with pulse signals, much more instantaneous current is provided to the infrared LEDs, and thereby the brightness of the dot lighting formed by the infrared LEDs 200 becomes much brighter. The narrower the width of the pulse signal is, the more instantaneous current is provided.

For example, as shown in FIG. 8, if t1=1/30 sec and t2=1 sec, the instantaneous current may increase by 30 times. When increasing the instantaneous current by 10 times, the brightness of the dot lighting may increase by 10 times and the power consumption may be reduced to one third.

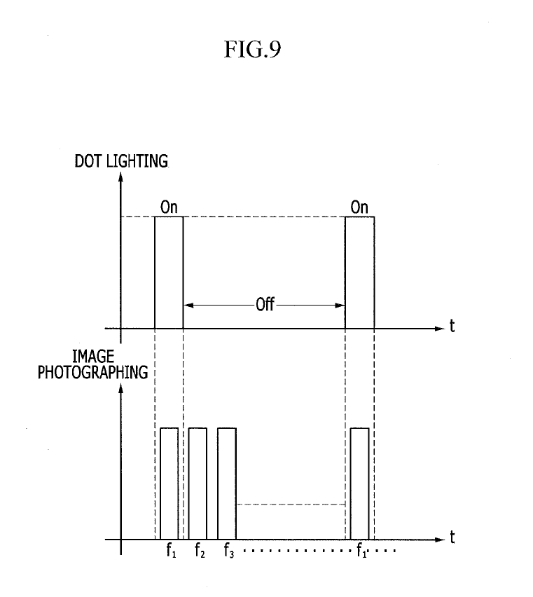

When the dot lighting unit 120 drives the infrared LEDs 200 with pulse signals, as shown in FIG. 9, unless synchronization with the photographing time of the intrusion monitoring camera unit 110 is performed, photographing an image is not possible. Therefore, the intrusion monitoring camera unit 110 generates a synchronization signal to drive the dot lighting unit 120.

The memory 130 stores reference information needed for determining whether intrusion occurs. Here, the reference information includes reference dot information and reference image information. The reference dot information represents an image which is obtained by photographing a security area with dot lighting in advance and a background image is removed therefrom. The reference image information represents an image which is obtained by photographing a security area in advance when an illumination lamp in the security area is turned on. In addition, the reference dot information further includes information on the number of dots included in the dot lighting, the brightness, positions, shapes, and sizes of dots included in the dot lighting, and other information. The reference dot information functions as reference data for determining whether intrusion occurs by the determining unit 140.

The intrusion determining unit 140 determines whether the intrusion occurs by comparing an image photographed by the intrusion monitoring camera unit 110 with reference information stored in the memory 130.

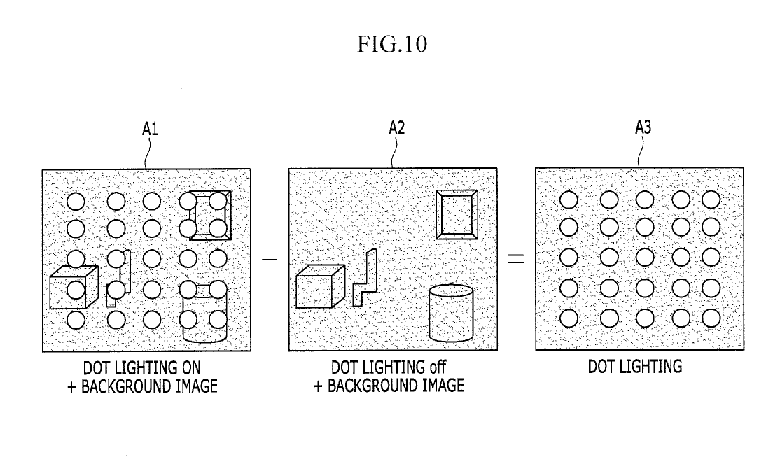

As shown in FIG. 10, when there is no intrusion, if a background image A2 that is obtained when dot lighting is not formed, that is, is turned off, is removed from an image A1 that is obtained when dot lighting is formed, that is, turned on, a dot image A3 is obtained. That is, it is satisfied that (a dot image+a background image) A1−(a back ground image) A2=a dot image A3.

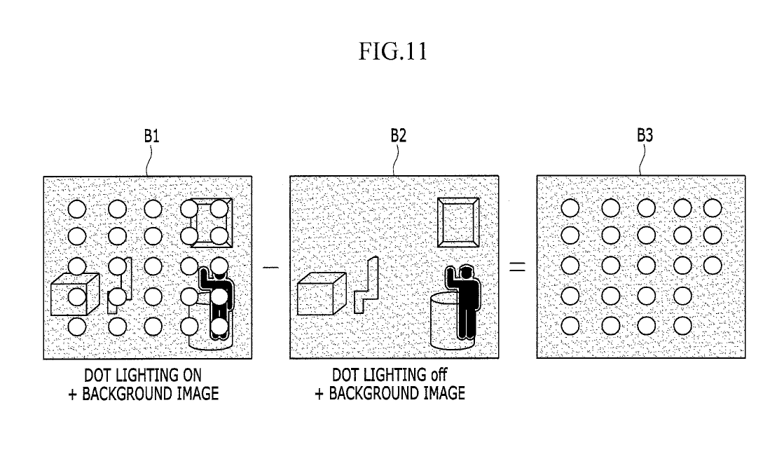

The intrusion determining unit 140, as shown in FIG. 11, when there is an intrusion, if a background image B2 that is obtained when dot lighting is turned off is removed from an image B1 that includes a dot image and a background image, a dot image B3 in which some dots are changed is obtained. Here, the change of the dots represents that the dots becomes invisible, the brightness or position of the dots changes, or the shape or the size of the dots changes.

The intrusion determining unit 140 may determine a size of an object based on the number of changed dots in the dot image, and may further determine that there is an intrusion when a dot group having a size corresponding to the size of a person is changed.

The controller 150 controls the intrusion monitoring camera unit 110, the dot lighting unit 120, the memory 130, and the intrusion determining unit 140 to control the entire operation of the imaging intrusion detection system 100.

The controller 150 controls the dot lighting unit 120 and the illumination lamp 120 to be turned on or off.

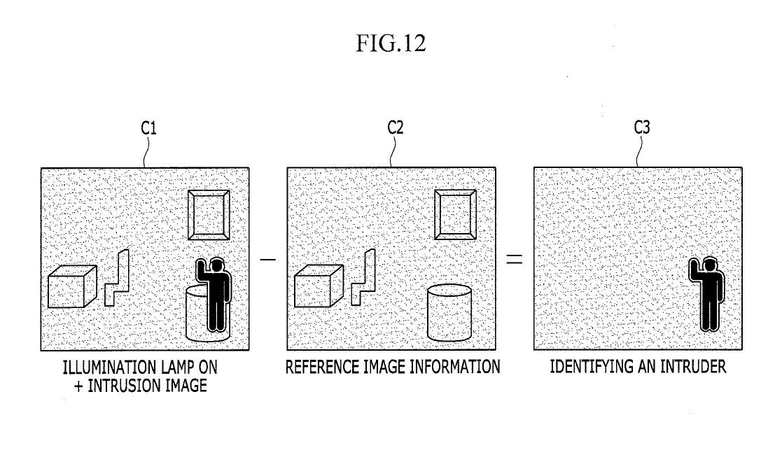

In addition, when it is determined that there is an intrusion by the intrusion determining unit 140, the controller 150, as shown in FIG. 12, turns the illumination lamp 160 on, controls the intrusion monitoring camera unit 110 to photograph an image C1, and removes the reference image information C2 stored in the memory 130 from the image C1 to obtain an intruder image C3.

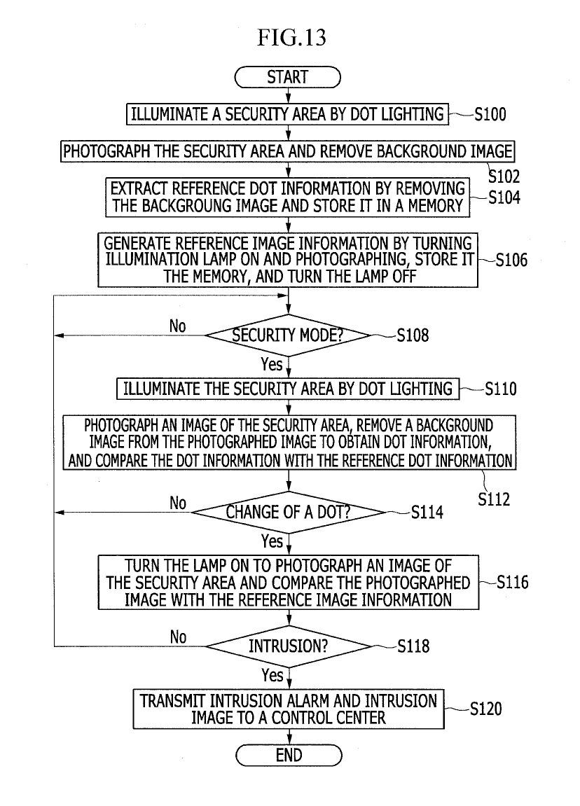

Next, an imaging intrusion detection method using dot lighting will be described with reference to FIG. 13.

FIG. 13 shows a flowchart of an imaging intrusion detection method using dot lighting according to an exemplary embodiment of the present invention.

The dot lighting 120 outputs a plurality of collimated light beams to illuminate a security area (S100).

The intrusion monitoring camera unit 110 photographs an image of the security area, removes a background image from the image to obtain reference dot information, and stores the reference dot information in the memory 130 (S102, S104).

The controller 150 turns the illumination lamp 160 in the security area on and controls the intrusion monitoring camera unit 110 to photograph an image of the security area, in order to generate reference image information. The controller 150 stores the reference image information in the memory 130 and turns the illumination lamp 160 off (S106).

When the imaging intrusion detection system 100 is set as a security mode, the controller 150 controls the dot lighting unit 120 to output a plurality of collimated light beams to illuminate the security area (S108 and S110).

The intrusion determining unit 140 controls the intrusion monitoring camera unit 110 to photograph an image of the security area, removes a background image from the photographed image to obtain dot information, and compares the obtained dot information with the reference dot information stored in the memory 130 (S112). The intrusion determining unit 140 obtains the dot information by removing the image that is obtained when the dot lighting is turned off from the image that is obtained when the dot lighting is turned on. That is, (a dot image+a background image)−(a background image)=a dot image (dot information).

The intrusion determining unit 140 determines whether dots increase or decrease, or whether the brightness, position, shape, or size of a dot is changed, based on the dot information.

The intrusion determining unit 140 determines that intrusion occurs when a value corresponding to the change of the dot information is higher than a first reference value (S114). Here, the first reference value represents the change of dots such that the total size of the dots corresponds to the size of a person.

The controller 150 controls the illumination lamp 160 to be turned on when receiving intrusion information from the intrusion determining unit 140.

The intrusion determining unit 140 controls the intrusion monitoring camera unit 110 to photograph an image of the security area and compares the image with the reference image information stored in the memory 130. When a value corresponding to the change between the image and the reference image information is higher than the second reference value, the intrusion determining unit 140 determines that there is an intrusion (S116 and S118). Here, the second reference value represents image information of the security area when there is no intrusion.

The intrusion determining unit 140 determines whether there is an intrusion by comparing the image that is obtained when the illumination lamp 160 is turned on and the reference image information stored in the memory 130 ((an intruder image+a background image)−(a background image)=(an intruder image)).

The controller 150 transmits an intrusion alarm and the intrusion image to a control center (S120), when there is an intrusion. When there is no intrusion, the controller 150 monitors for a predetermined time. If there is no intrusion although the predetermined time has been passed, the controller 150 controls the illumination lamp 160 to be turned off and does not transmit the intrusion image to the control center.

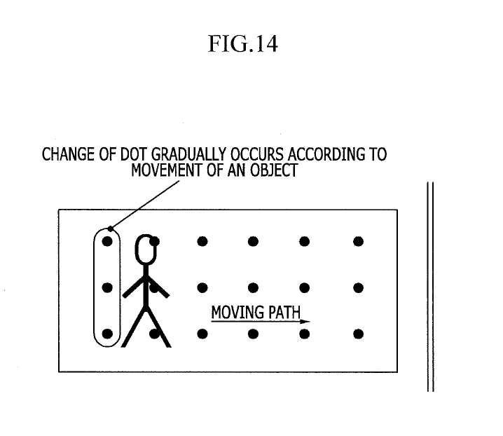

If a change of the dot group caused by intrusion occurs, the intrusion determining unit 140, as shown in FIG. 14, calculates the size of the intrusion object based on the number and area of the dots in which the change occurs among the dots of the dot group.

The intrusion determining unit 140 monitors the movement of the object when the number and area of the changed dots correspond to the size of a person. As shown in FIG. 14, if the object moves to the right, the dot group in which the change occurs moves to the right in the image.

The intrusion determining unit 140 may determine whether the object is a person based on the movement speed of the changed dot group and track the movement path of the objet by tracking the moving path of the dot group.

The intrusion determining unit 140 determines whether the infrared LEDs 200 are out of order since the number of dots included in the dot lighting changes when one of the infrared LEDs is out of order. That is, the intrusion determining unit 140 may identify a dot that has not been turned on, that is, a light source (an infrared LED 200) when the dot lighting is turned on or turned off.

Meanwhile, the reason for removing the background image is that it is difficult to distinguish a change of a background image caused by outside light and a change of an image caused by an intrusion, which causes a false alarm.

When white noise is included in the background image, an error in identifying an image occurs. That is, (an intrusion image+a background image+noise)−(a background image+noise)=(an intrusion image+noise) is satisfied. In this case, if the noise is very small in relation to the intrusion image, the false alarm does not occur. If not, the false alarm occurs.

Next, a method for reducing the white noise will be described.

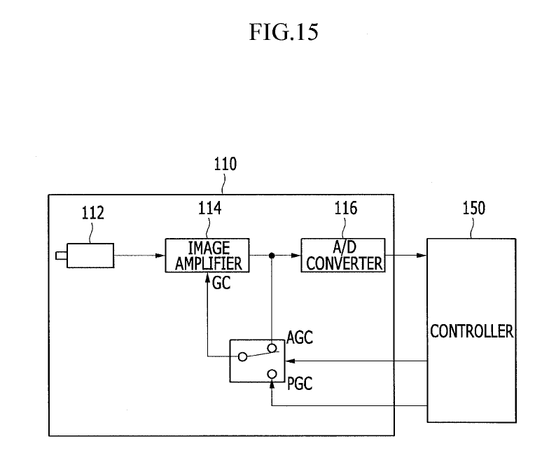

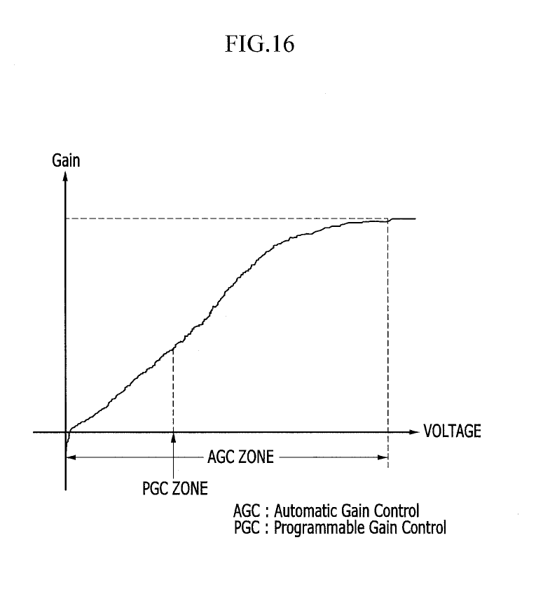

FIG. 15 and FIG. 16 show a method for reducing the effect of white noise according to an exemplary embodiment of the present invention.

As shown in FIG. 15, an image amplifier 114 amplifies the output of an image camera 112. The image amplifier 114 has an automatic gain control (AGC) function.

As shown in FIG. 16, based on the AGC, the amplification degree is wildly controlled based on the gain control voltage.

The controller 150 generates a suitable gain control voltage to control the amplification degree to not increase much, by blocking the AGS to reduce the white noise. This will be referred to as programmable gain control (PLC) based on software.

The controller 150 monitors the output of the image amplifier 114 through an analog/digital (AD) converter 116, and controls the image amplifier 114 to maintain an optimum state of the amplification degree in which there is no noise.

Also, the controller 150 controls the amplification degree of the image amplifier 114 so that the brightness of the dots is not saturated.

Based on the PLC, the controller 150 monitors the size of the signal corresponding to the dot image and controls the amplification degree to be suitable for the dot image. For example, the controller 150 reduces the amplification degree based on the dot image when the brightness of the dot image is much higher than that of the image corresponding to the surrounding of the dot image, so that the surrounding image and noise become almost nothing and the dot image is remained and extracted.

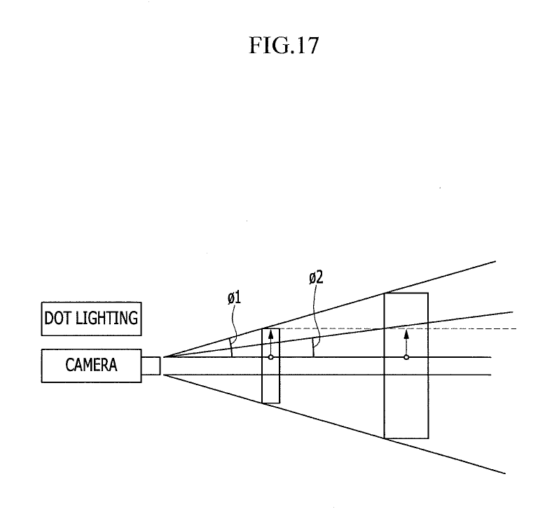

Next, referring to FIG. 17, the principle for measuring the size of the trespassed object will be described.

FIG. 17 shows a principle of measuring angle of view and size of an object by positions in a security area according to an exemplary embodiment of the present invention.

The angle of view (φ) of the image camera 112 increases as an object is closer to the image camera 112 and decreases as an object is farther away from the image camera 112.

The intrusion determining unit 140 measures angle of view from place to place in the security area and forms a lookup table based on the measured angle of view by positions to store it in the memory 130. In a security mode, the intrusion determining unit 140 measures angle of view of the image camera by positions and determines whether there is an intrusion by measuring the size of an object by referring to the lookup table based on the measured angle of view.

An exemplary embodiment of the present invention may not only be embodied through the above-described apparatus and/or method, but may also be embodied through a program that executes a function corresponding to a configuration of an exemplary embodiment of the present invention and through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An imaging intrusion detection method for an imaging intrusion detection system by using an image recognition technique, the imaging intrusion detection method comprising:
generating a plurality of collimated light beams by respectively combining condensing lenses with a plurality of light sources and illuminating a security area by the plurality of collimated light beams to form dot lighting;
obtaining a dot image of the security area to which the dot lighting is illuminated by an intrusion monitoring camera and storing the obtained dot image in a memory as reference dot information; and
photographing the security area to which the dot lighting is illuminated at predetermined intervals to obtain an input image, extracting dot information from the input image to compare the dot information with the reference dot information, and determining whether there is intrusion in the security area according to a change of a dot based on a result of comparison.

2. The imaging intrusion detection method of claim 1, further comprising:
photographing a first image of the security area in which an illumination lamp is turned on by the intrusion monitoring camera and storing the first image in the memory as the reference image information; and
photographing a second image of the security area in which the illumination lamp is turned on by the intrusion monitoring camera when it is determined that there is an intrusion and comparing the second image with the reference image information to finally determine an intrusion.

3. The imaging intrusion detection method of claim 1, wherein the determining of whether there is an intrusion includes comparing a number of dots included in the dot information and a number of dots included in the reference dot information, and determining that there is an intrusion when a difference between them is higher that a predetermined value.

4. The imaging intrusion detection method of claim 1, wherein the determining of whether there is an intrusion includes comparing brightness of the dot information and brightness of the reference dot information, and determining that there is an intrusion when a difference between them is higher that a predetermined value.

5. The imaging intrusion detection method of claim 1, wherein the determining of whether there is an intrusion includes comparing positions of dots included in the dot information and positions of dots included in the reference dot information and determining that there is an intrusion when a difference between them is higher that a predetermined value.

6. The imaging intrusion detection method of claim 1, wherein the determining of whether there is intrusion includes comparing shapes or sizes of dots included in the dot information and shapes or sizes of dots included in the reference dot information and determining that there is an intrusion when a difference between them is higher that a predetermined value.

7. The imaging intrusion detection method of claim 1, further comprising:
obtaining a difference between an image of the security area when the dot lighting is turned on and an image of the security area when the dot lighting is turned off, and extracting the reference dot information or the dot information.

8. The imaging intrusion detection method of claim 1, wherein the plurality of light sources are arranged in a form of a zigzag with an optical axis of the intrusion monitoring camera as its center.

9. An imaging intrusion detection system using an image recognition technique, the imaging intrusion detection system comprising:
a dot lighting unit in which a plurality of light sources are respectively combined with condensing lenses to form a plurality of collimated light beams, and that illuminates a security area with the plurality of collimated light beams to form dot lighting; and
an intrusion determining unit that sets a dot image of the security area in which the dot lighting is illuminated as reference dot information, and when an input image for the security area is obtained, extracts dot information from the input image, compares the dot information with the reference dot information, and analyzes a change of a dot to determine whether there is an intrusion.

10. The imaging intrusion detection system of claim 9, wherein the intrusion determining unit, based on a result of comparison of the extracted dot information and the reference dot information, analyzes at least one of a number of dots, brightness of a dot, size of a dot, and shape of a dot to determine whether there is an intrusion.

11. The imaging intrusion detection system of claim 9, wherein the intrusion determining unit, based on a result of comparison of the extracted dot information and the reference dot information, calculates a size of an object that has trespassed in the security area by using the area and number of dots that have changed.

12. The imaging intrusion detection system of claim 9, wherein the intrusion determining unit, when a change of dots occurs based on a result of comparison of the extracted dot information and the reference dot information, traces a moving path of an object that has trespassed in the security area by using a speed of change of the dots.

13. The imaging intrusion detection system of claim 9, wherein the intrusion determining unit measures an angle of view of a camera by positions in the security area, stores a lookup table based on the measured angle of view in a memory, measures a size of an object that has trespassed in the security area based on referring to the lookup table with an angle of view measured in a security area to determine whether there is an intrusion.

14. The imaging intrusion detection system of claim 9, wherein the intrusion determining unit determines whether a light source is out of order based on a difference between a number of dots included in the extracted dot information and a number of dots included in the reference dot information.

15. The imaging intrusion detection system of claim 9, wherein the dot lighting unit drives the plurality of light sources with a pulse signal, provides instantaneous current that is larger that a predetermined current to the plurality of light sources, and synchronizes the driving of the plurality of light sources with a photographing time of a camera.
